(19) United States
(12) Patent Application Publication
(10) Pub. No.: US 2004/0215695 A1
(43) Pub. Date: Oct. 28, 2004

(54) Method and system for implementing accurate and convenient online transactions in a loosely coupled environments

(76) Inventors: Sue-Chen Hsu, Shijr City (TW); Chih-Hao Hsu, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/403,325

(22) Filed: Mar. 31, 2003

(51) Int. Cl. G06F 15/16

(52) U.S. Cl. 709/201

(57) ABSTRACT

A system for implementing accurate and convenient OLTP (OnLine Transaction Processing) in a loosely coupled environment. The system includes a client with a client ID set in a request scope object and a server with a server ID set in a session scope object. The OLTP system determines whether a back-end operation acting on a database is a transaction operation by detecting the client and server IDs and then responds by performing corresponding operations.

### BACKGROUND OF THE INVENTION

1. Field of the Invention

The present invention relates to an OLTP (OnLine Transaction Processing) system and method, and in particular to an accurate and convenient OLTP system in a loosely coupled environment for preventing unnecessary transaction processes to lower loading of a database.

2. Description of the Related Art

In a loosely coupled environment, such as the Internet, a server is not closely connected to a client. Because of the open interface, user actions are difficult to govern, and thus, applications used on the Internet are frequently subject to non-system errors.

When users, for example, enter a shopping site on the Internet, they enter the required information and then enter a transaction page to pay. Users often have to fill in product or personal information on the billing page. The system of the shopping site returns error messages if users double click a confirmation button or repeat the transaction, mistakenly assuming transaction failure, when, in fact, the transaction has been successfully completed. In another situation, the transaction has been successfully completed, but the system of the shopping site registers additional unwanted transactions. Obviously, such errors in business transaction platforms can easily cause serious problems.

Conventional OLTP (OnLine Transaction Processing) systems utilize a database or script to govern user actions. The method of database control has little influence on use, when significantly slowing system response because of frequent access to the database and resulting load increase. Possible remedies using script control limit use in the database, causing user inconvenience, although better performance and lighter database loading are provided.

Transaction applications traditionally have no set standards, so errors arise frequently. Sometimes users may re-submit because of slow server response, under the mistaken impression that the transaction has failed or the server has crashed, when, in fact, the transaction has been completed. Some transaction operations are incomplete or repeated because of ill-informed use of the browser's back and refresh buttons. Inaccurate or repeat billings result.

The database experiences heavy loading if the platform utilizes database control. Use is restricted and made less convenient if the platform utilizes script control, although the database experiences lighter loading. Nevertheless, user actions cannot be governed completely if users make use of browser controls. Most important of all, many script operations are required by the transaction.

### SUMMARY OF THE INVENTION

Accordingly, an object of the present invention is to provide a method for implementing accurate and convenient OLTP (OnLine Transaction Processing) operations.

According to the object described above, the present invention provides a method for implementing accurate and convenient transactions in a loosely coupled environment. First, a client ID is set in a request scope object and a server ID is set in a session scope object on a platform in which the value of the client ID is equal to that of the server ID. A back-end operation is performed in the request scope object and it is then determined whether the back-end operation is a transaction operation for a database. The back-end operation is free to execute when the back-end operation is not a transaction operation. Next, it is determined whether the value of the server ID is equal to that of the client ID when the back-end operation is a transaction operation. An error page is then generated without performing the back-end operation when the value of the server ID is not equal to that of the client ID, and the value of the server ID and the client ID are normalized. The value of the server ID is increased by one and it is then determined whether the back-end operation has been successfully performed when the value of the server ID is equal to that of the client ID. The following page is opened when the back-end operation has been successfully performed, and one is added to the value of the client ID. Finally, one is subtracted from the value of the server ID if the back-end operation fails, and an error page is generated, returning to the transaction page.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1A˜1B are a flowchart showing the method for implementing accurate and convenient transactions in a loosely coupled environment of the present invention.

### DETAILED DESCRIPTION OF THE INVENTION

Accordingly, the present invention discloses an OLTP (OnLine Transaction Processing) system applied in a loosely coupled environment to provide accurate and convenient online transactions.

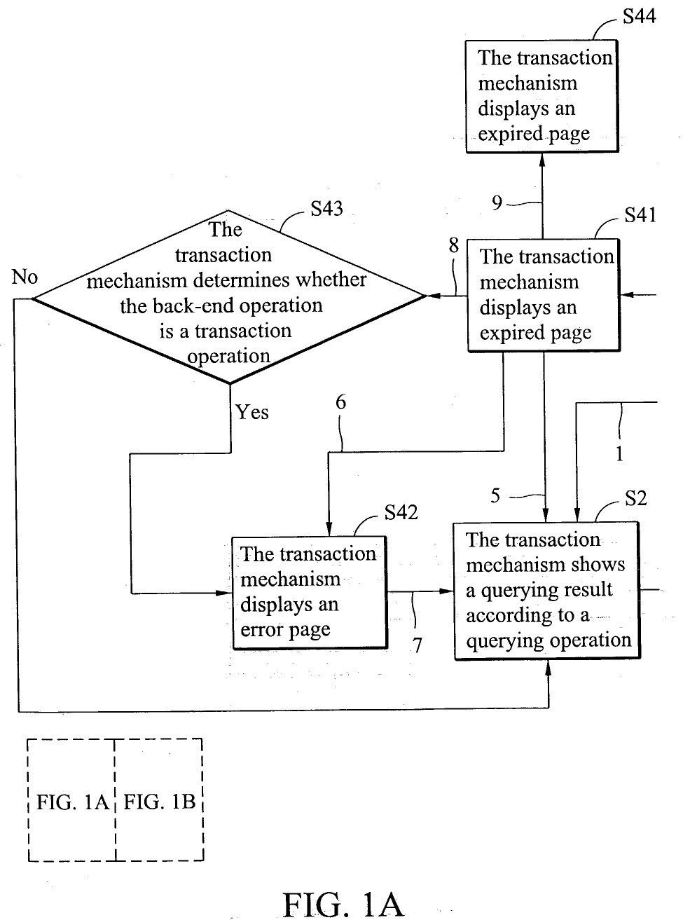

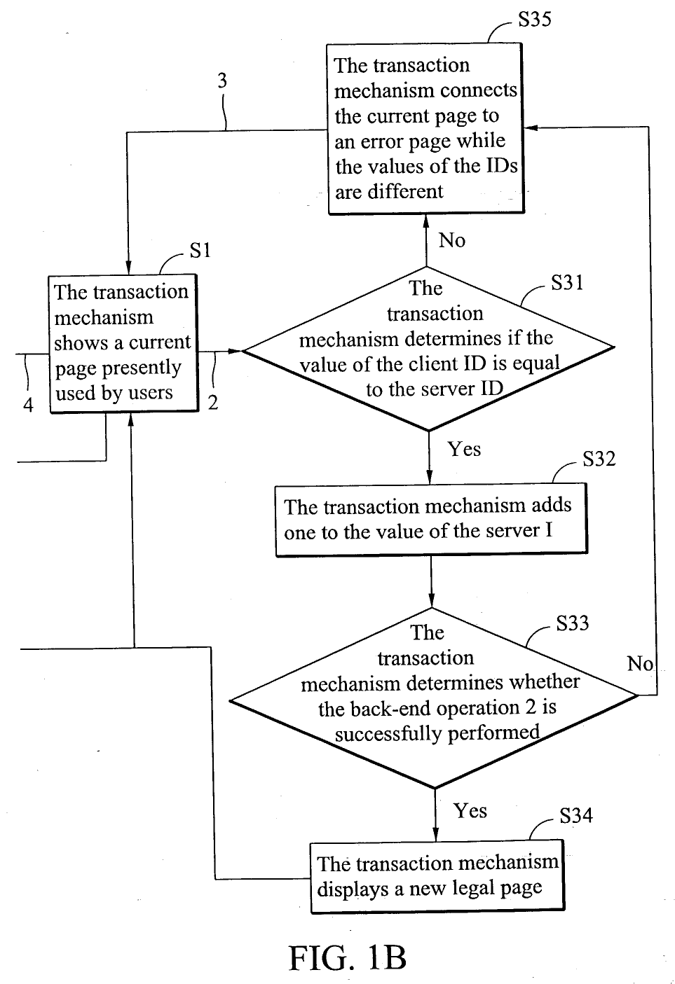

FIG. 1A˜1B is a flowchart showing the method for implementing accurate and convenient transactions in a loosely coupled environment of the present invention. The flow is described as follows.

First, a client ID is set in a request scope object and a server ID is set in a session scope object according to the OLTP system system, in which the value of the client ID is equal to that of the server ID at the beginning of the transaction.

In S1, the OLTP system shows a page currently in use. The current page is a fully operational page in which the value of the client ID is equal to that of the server ID. Users can execute query, addition, update, delete, return, and refresh operations in the current page.

In S2, the OLTP system shows a query result according to a querying operation. The OLTP system shows the query result when users execute query operation 1, and adds one to the values of both the client and server IDs such that their values remain equal. The query page is now presented as the current page after displaying the query result.

In S31, the OLTP system determines if the value of the client ID is equal to that of the server ID. The OLTP system determines whether the value of the client ID is equal to that of the server ID to determine whether to continue operations when users perform a back-end operation 2 that it is a transaction operation. If so, the process goes to S32, if not, the process goes to S35.

In S32, the OLTP system adds one to the value of the server ID. The OLTP system adds one to the value of the server ID when the value of the client ID is equal to that of the server ID, and then continues operations.

In S33, the OLTP system determines whether the back-end operation 2 has been successfully performed. After adding one to the value of the server ID, the back-end operation 2 is performed. Because the back-end operation 2 may fail in some situations, the OLTP system has to determine if back-end operation 2 has been successfully performed. If so, the process goes to S34, if not, the process goes to S35.

In S34, the OLTP system displays a new fully operational page. The OLTP system connects the current page to the next fully operational page and adds one to the value of the client ID when successfully performing the back-end operation 2. The transaction procedure in the page in S34 namely the current page in S1 is repeated when users want to continue the transaction.

In S35, the OLTP system connects the current page to an error page when the ID values are different. The OLTP system determines that the value of the client ID is not equal to that of the server ID and then connects the current page to the error page, normalizing the client and server IDs. The error page can return to the fully operational page in S1 directly by the OLTP system or by performing return operation 3.

In S41, the OLTP system displays an expired page. The OLTP system returns the current page to the previous page when users execute a return operation 4, in which one is subtracted from the value of the client ID but not the server ID. The previous page is defined as the expired page by the executed operations. Users can perform back-end operations such as addition, update, deletion, return, and refresh. The OLTP system connects the expired page in S41 to the query result page in S2 when users execute a querying operation 5 and then return operation.

In S42, the OLTP system displays an error page. The OLTP system fails to perform a transaction operation 6 to display an error page because of the value of client ID is not equal to that of the server ID in S41 and thereby the value of the client ID in S41 doesn't change. The OLTP system connects the error page in S42 to the query result page in S2 when users execute a querying operation 7 and then re-normalizes the client and server IDs.

In S43, the OLTP system determines whether the back-end operation is a transaction operation. When users execute a refresh operation 8 that repeats the back-end operation from the previous page, the OLTP system determines whether the back-end operation is a transaction operation. If so, the process goes to the error page in S42 because the value of the client ID is not equal to that of the server ID, and, if not, the process goes to the query result page in S2 and the OLTP system re-normalizes the client and server IDs.

In S44, the OLTP system displays an expired page. If users continuously perform a return operation 9, the pages displayed by the OLTP system are expired pages. The expired page can be returned to a fully operational page to continue the transaction unless users execute a subsequent operation.

The OLTP system of the present invention clearly and completely defines transaction architecture to easily govern transactions on the whole system, preventing users from mistakenly using the browser's back and refresh buttons. As well, the client is prevented by the client ID from executing spurious transaction procedures, while database loading is relieved by fewer login and logout operations.

Comparison of control methods and effects between the OLTP system of the present invention and conventional methods is described as follows:

The database control method adds fields to a table in the database, and checks the data when users gain access. The main drawback is heavy loading in the database because of frequent access. It is important to OLTP (OnLine Transaction Processing) systems to shorten response time in the database, and this method obviously neglects this consideration.

The script control method locks keys on the keyboard and hides browser toolbars to restrict user actions. This method still cannot completely govern users' actions, for example, users can still access browser navigation buttons.

The method of the present invention adds control codes to be checked at the client and the server. By checking the control codes to provide user access to the database for execution of precise transaction operations. The method of the present invention does not limit user operations, while lightening database loading, thereby solving the problems inherent in the previous methods.

When the invention has been described by way of example and in terms of the preferred embodiments, it is to be understood that the invention is not governed to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A system for implementing accurate and convenient OLTP (OnLine Transaction Processing) operations in a loosely coupled environment, comprising:
a client, whose ID is set in a request scope object;
a server, coupled to the client, whose ID is set in a session scope object; and
a database, coupled to the server,
wherein the client and server IDs are detected and compared corresponding to execution of a back-end operation.

2. The system as claimed in claim 1, wherein the value of the client ID is equal to that of the server ID at the beginning of the OLTP process.

3. The system as claimed in claim 1, wherein the back-end operation affecting the database includes query, addition, update and erase operations.

4. The system as claimed in claim 3, wherein the back-end operation is a transaction operation which can add, update and erase data in the database.

5. A method for implementing accurate and convenient transactions in a loosely coupled environment, comprising the steps of:
setting a client ID in a request scope object and a server ID in a session scope object on a platform in which the value of the client ID is equal to that of the server ID;
performing a back-end operation in the request scope object and determining if the back-end operation is a transaction operation for a database coupled to the server;
allowing the back-end operation if the back-end operation is not a transaction operation;
determining if the value of the server ID is equal to that of the client ID when the back-end operation is a transaction operation;
connecting to an error page without performing the back-end operation when the value of the server ID is not equal to that of the client ID, and normalizing the value of the server ID and the client ID;
adding one to the value of the server ID and then determining whether the back-end operation has been successfully performed when the value of the server ID is equal to that of the client ID;
connecting to a following page when the back-end operation has been successfully performed, and adding one to the value of the client ID; and
subtracting one from the value of the server ID when the back-end operation fails, connecting to the error page and then returning to the transaction page.

6. The device as claimed in claim 5, wherein the server ID is set in the session scope object of the server.

7. The device as claimed in claim 5, wherein the back-end operation is performed on the server and the database.

8. The device as claimed in claim 5, wherein the back-end operation directly performed on the database reads, modifies or queries the data therein.

9. The device as claimed in claim 5, wherein the transaction operation is a back-end operation adding data to, deleting data from, or updating data in the database.

10. The device as claimed in claim 5, wherein the transaction operation is performed and a return operation is performed when the transaction operation fails to open the error page, returning to a fully operational page of the desired transaction operation to re-perform the transaction operation.

11. The device as claimed in claim 12, wherein after performing the return operation and a refresh operation, repeating the steps from the performing step to the subtracting step if the desired transaction operation is performed.

14. The device as claimed in claim 5, wherein the client and server IDs are located in different session scope objects.

15. The device as claimed in claim 14, wherein the client and server Ids are compared to each other in different scope objects.

16. The device as claimed in claim 14, wherein the values of the client and server IDs are numbers or characters
